(19) United States
(12) Patent Application Publication
(10) Pub. No.: US 2015/0058648 A1
(43) Pub. Date: Feb. 26, 2015

(54) APPARATUS AND METHOD FOR SAVING POWER IN A COMPUTER SYSTEM

(71) Applicant: Electronics and Telecommunications Research Institute, Daejeon (KR)

(72) Inventors: Byeong Thaek Oh, Daejeon (KR); SungIk Jun, Daejeon (KR); Baik Song An, Seoul (KR); Byung-gyu Lee, Daejeon (KR)

(21) Appl. No.: 14/453,248

(22) Filed: Aug. 6, 2014

(30) Foreign Application Priority Data
Aug. 20, 2013 (KR) 10-2013-0098657

(51) Int. Cl. G06F 1/32

(52) U.S. Cl. CPC G06F 1/3206; G06F 1/3287
USPC 713/323; 713/320

(57) ABSTRACT

An apparatus for power saving in a computer system is configured to register a power saving policy for the computer system, control the power to at least one auxiliary device of the computer system based on the computer system's power consumption information and the power saving policy, and collect and transmit the computer system's status information to a power and status display mounted at a remote location so as to display the computer system's power consumption information and status information.

### CROSS-REFERENCE TO RELATED APPLICATION

This application claims priority to and the benefit of Korean Patent Application No. 10-2013-0098657 filed in the Korean Intellectual Property Office on Aug. 20, 2013, the entire contents of which are incorporated herein by reference.

### BACKGROUND OF THE INVENTION

(a) Field of the Invention

The present invention relates to an apparatus and method for saving power in a computer system, and more particularly, to a technique for providing users with a computer system's status and power consumption information in order to reduce the computer system's power consumption.

(b) Description of the Related Art

In line with higher performance and larger capacity IT systems including personal computer systems, energy use is increasing, and power consumption in the IT sector continues to increase, compared to power consumption in the manufacturing sector. For this reason, energy saving technology in the IT sector is drawing increasing attention in recent years. A typical example of the energy saving technology for IT systems includes low power design technology. Low power design technology is a technology for minimization of peak power and power leakage, which is widely used in hardware design, with a focus on low-power hardware.

However, just as cars, even with good fuel ratios, they cannot save fuel if drivers have bad driving habits or stick to the use of equipment that is unnecessary for the operation, it could be hard to save power in computer systems as intended with only low-power hardware design.

In this regard, the screensaver function can be used to reduce the power consumption of display devices, which are known to consume a lot of power, in computer systems. However, the problem that the display devices still consume power even when the screensaver is active remains. Also, the brightness of the backlight of a display can be adjusted, which, however, does not save much power.

In addition, power consumption can be greatly reduced by turning off the display device for power saving. However, with the display device turned off, it keeps the user from knowing the current status of the computer system's main body. Since the user does not know the computer system's status when the display device is in an off condition, the user often ends the computer operation by mistake or wakes up the computer system and returns it to its original state. In this case, unnecessary power is consumed when returning the computer to its original state, resulting in a waste of electricity.

### SUMMARY OF THE INVENTION

The present invention has been made in an effort to provide an apparatus and method for power saving in a computer system, which can provide users with the computer system's status and power consumption information even when a display device of the computer system is in a power saving mode or a screensaver mode, or in an off condition.

In addition, the present invention has been made in an effort to provide an apparatus and method for power saving in a computer system, which enable the computer system to operate in a power saving mode or return to a normal mode, without using an input device on the computer system.

An exemplary embodiment of the present invention provides an apparatus for power saving in a computer system. The power saving apparatus includes a policy register, a power saving controller, and a power and status display. The policy register registers a power saving policy for the computer system. The power saving controller collects the computer system's status information and power consumption information, and controls the power to at least one auxiliary device of the computer system based on the computer system's status information and the power saving policy. The power and status display is mounted at a remote location, and displays the computer system's power consumption information and status information.

The power saving apparatus may further include a remote status transmitter. The remote status transmitter transmits the computer system's power consumption information and status information to the power and status display by wired or wireless communication.

The computer system may include a processor, a memory, an input/output (I/O) interface, and a communication unit. The processor may load program instructions to the memory to implement at least some of the functions of the policy register, power saving controller, and remote status transmitter, and the computer system's power consumption information and status information may be transmitted to the power and status display via the I/O interface or the communication unit.

The power and status display may include: a display that displays the computer system's power consumption information and status information; and a power supply unit that supplies power to the power and status display.

The power and status display may further include: an I/O interface or communication unit that receives the computer system's power consumption information and status information; and an input unit that receives user input of information on the power saving policy, power saving mode, and power on/off mode.

The remote location may include at least one of a main body of the computer system, a bezel of a monitor, a user's mobile terminal, a keyboard, and a position within a predetermined distance of the computer system.

The power saving controller may turn off the power to the display device of the computer system based on the status information when the computer system operates in a power saving mode, and the power saving mode may include at least either a standby mode or a screensaver mode.

Another exemplary embodiment of the present invention provides a method for power saving in a computer system by a power saving apparatus.

The power saving method includes: receiving the computer system's power consumption information; collecting the computer system's status information; controlling power to at least one auxiliary device of the computer system according to the computer system's status information and an established power saving policy; and transmitting the computer system's power consumption information and status information to a display device at a remote location so that the display device at the remote location displays the computer system's power consumption information and status information.

The controlling may include: detecting activation of a power saving mode according to the status information and the power saving policy; and turning off power to the display device of the computer system when the power saving mode is active.

The controlling may include receiving input of the power saving policy from the user or through the computer system.

The remote location may include at least one of a main body of the computer system, a bezel of a monitor, a user's mobile terminal, a keyboard, and a position within a predetermined distance of the computer system, and the display device may be mounted as a patch at the remote location.

The power saving method may further include: receiving control instructions for the computer system from the user; and transmitting the control instructions to the computer system.

### BRIEF DESCRIPTION OF THE DRAWINGS

FIG. 1 is a view showing an apparatus for power saving in a computer system according to an exemplary embodiment of the present invention.

FIG. 2 is a flowchart showing a power saving method of a power saving apparatus according to an exemplary embodiment of the present invention.

FIG. 3 is a flowchart showing a method for transmitting a computer system's power consumption information and status information according to an exemplary embodiment of the present invention.

FIG. 4 is a flowchart showing a method of controlling a computer system using a power and status display according to an exemplary embodiment of the present invention.

FIG. 5 is a schematic view of a computer system according to an exemplary embodiment of the present invention.

FIG. 6 is a view showing the power and status display of FIG. 1.

FIGS. 7 to 12 are views showing an example of mounting of the power and status display of FIG. 6.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Now, an apparatus and method for power saving in a computer system according to an exemplary embodiment of the present invention will be described in detail with reference to the drawings.

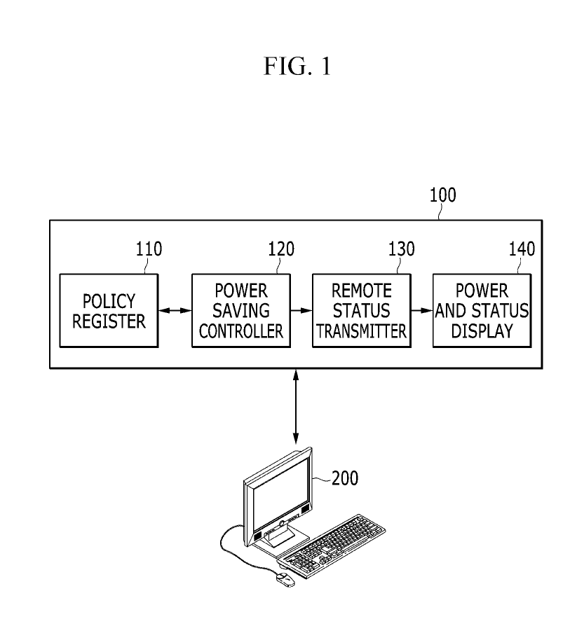

FIG. 1 is a view showing an apparatus for power saving in a computer system according to an exemplary embodiment of the present invention.

Referring to FIG. 1, the power saving apparatus 100 includes a policy register 110, a power saving controller 120, a remote status transmitter 130, and a power and status display 140.

The policy register 110 registers a power saving policy for the computer system 200. For example, the policy register 110 may register a power saving policy that sets a computer system 200 to standby mode, power saving mode, full power saving mode, or screensaver mode if the computer system 200 is not operated for a set period of time by the user, and shuts off the power to a display device of the computer system 200.

The power saving controller 120 collects the computer system 200's status information, usage state information, and power consumption information. The power saving controller 120 controls the power to an auxiliary device, for example a display device of the computer system 200, based on the status information, usage state information, and power saving policy. At this point, the computer system 200 can actually control the power to auxiliary devices by power control of the power saving controller 120. The status information may include the computer system 200's advanced configuration and power interface (ACPI) state and mode setting information for the power saving policy. In case of a computer system using a battery, the status information may further include remaining battery level information. In addition, the status information may further include temperature and humidity in the computer system 200, voltage and current of a power supply device, and internal fan speed.

Moreover, the power saving controller 120 forwards the collected power consumption information and status information about the computer system 200 to the remote status transmitter 130.

The remote status transmitter 130 transmits the computer system 200's power consumption information and status information to the power and status display 140.

The power and status display 140 displays the computer system's power consumption information and status information.

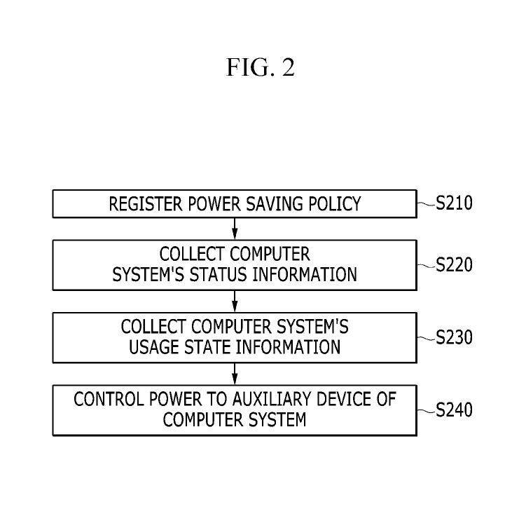

FIG. 2 is a flowchart showing a power saving method of a power saving apparatus according to an exemplary embodiment of the present invention.

Referring to FIG. 2, the power saving controller 120 registers a power saving policy (S210).

The power saving controller 120 collects the computer system 200's status information (S220), and collects the computer system 100's usage state information (S230). For example, if the user does not use the computer system 200 for a specific period of time, an event that activates the screensaver of the computer system 200 can be detected based on the use state information.

The power saving controller 120 controls the power to the auxiliary devices of the computer system 200 according to the collected status information and usage state information about the computer system and the power saving policy (S240). For example, when an event occurs which causes the screensaver to operate in a power saving mode, the power saving controller 120 can recognize the instant when the screensaver event occurs and turn off the power to the display device 280 of the computer system 200.

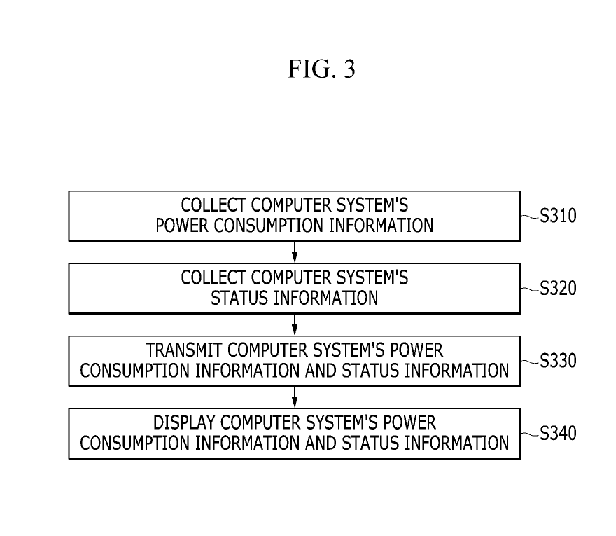

FIG. 3 is a flowchart showing a method for transmitting a computer system's power consumption information and status information according to an exemplary embodiment of the present invention.

Referring to FIG. 3, the power saving controller 120 collects power consumption information measured by a power supply device, etc., of the computer system 200 (S310).

The power saving controller 120 collects the computer system 200's status information (S320).

The remote status transmitter 130 transmits the computer system 200's power consumption information and status information to the status display 140 (S330).

The power and status display 140 displays the computer system 200's power consumption information and status information (S340).

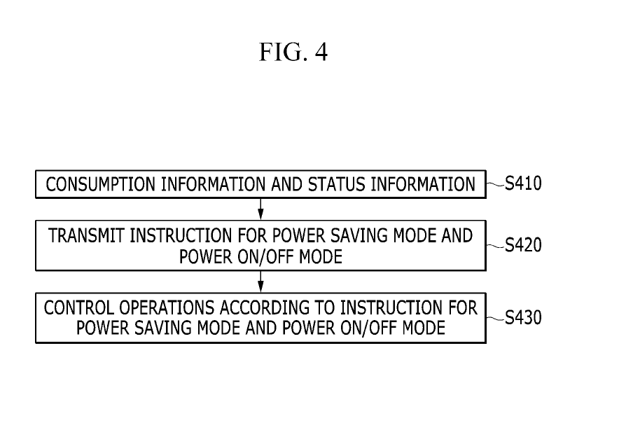

FIG. 4 is a flowchart showing a method of controlling a computer system using a power and status display according to an exemplary embodiment of the present invention.

Referring to FIG. 4, the power and status display 140 may receive instructions for a power saving mode and a power on/off mode from the user (S410).

The power and status display 140 transmits the instructions for the power saving mode and the power on/off mode received from the user to the computer system 200 (S420).

The computer system 200 controls operations according to the instructions for the power saving mode and the power on/off mode (S430). For the instructions for power off, for example, the computer system 200 may turn the power off. In this way, the user can control the computer system 200 with ease by using the power and status display 140 from a remote place.

At least some of the functions of the policy register 110, power saving controller 120, and remote status transmitter 130 of the power saving apparatus 100 explained in FIGS. 2 to 4 may be combined with the computer system 200 and implemented in hardware or software attached to it.

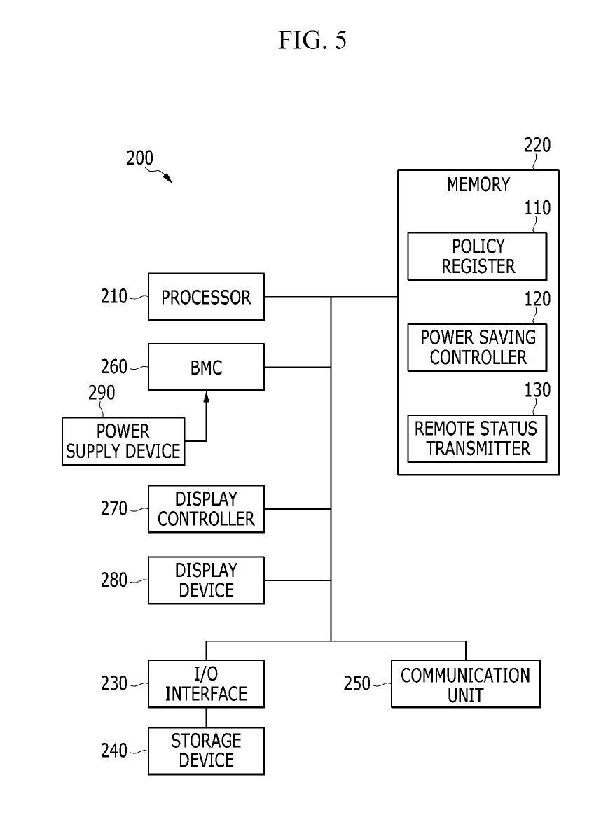

FIG. 5 is a schematic view of a computer system according to an exemplary embodiment of the present invention.

Referring to FIG. 5, the computer system 200 includes a processor 210, a memory 220, a storage device 230, an input/output (I/O) interface 240, a communication unit 250, a BMC (baseboard management controller) 260, a display controller 270, and a display device 280. The computer system 200 may further include a power supply device 290.

The processor 210 may be implemented as a central processing unit (CPU), a chipset, a microprocessor, etc.

The memory 220 may be implemented as media such as a dynamic random access memory (DRAM), a Rambus DRAM (RDRAM), a synchronous DRAM (SDRAM), and a static RAM (SRAM).

The storage device 230 may be implemented as optical disks, such as a hard disk, a CD-ROM (compact disk read only memory), a CD-RW (CD rewritable), a DVD-ROM (digital video disk ROM), a DVD-RAM, a DVD-RW disk, and a blue-ray disk, a flash memory, and various types of permanent or volatile storage devices, such as RAM.

The I/O interface 240 allows the processor 210 and/or the memory 220 to access the storage device 230.

The communication unit 250 allows the processor 210 and/or the memory 220 to access a network.

In this case, the processor 210 can load program instructions to the memory 220 to implement at least some of the functions of the policy register 110, the power saving controller 120, and the remote status transmitter 130, and control such that the above-described operations are carried out with, reference to FIG. 1. Such program instructions may be stored in the storage device 230, or in other systems connected to the network. The power and status display 140 receives power consumption information and status information via the I/O interface of the computer system 200. The power and status and display 140 can exchange information with the computer system 200 by wireless communication, and receive power consumption information and status information by wireless communication.

The BMC 260 is connected to the power supply device 290 via a power management bus (PMBus) or I2C (inter-integrated circuit) bus, and monitors the power supply device 290's power usage information and provides it to the power saving apparatus 100 via the power management bus (PMBus) or 120 (inter-integrated circuit) bus.

The display controller 270 controls the display device 280.

The display device 280 corresponds to, for example, a monitor of the computer system 200.

The power supply device 290 converts AC voltage into DC voltage and supplies it to the computer system 200. The power supply device 290 measures the power consumption information of the computer system 200, and forwards the power consumption information of the computer system 200 to the BMC 260. In addition, the power supply device 290 can control the power usage of the computer system 200 based on the power consumption information of the computer system 200.

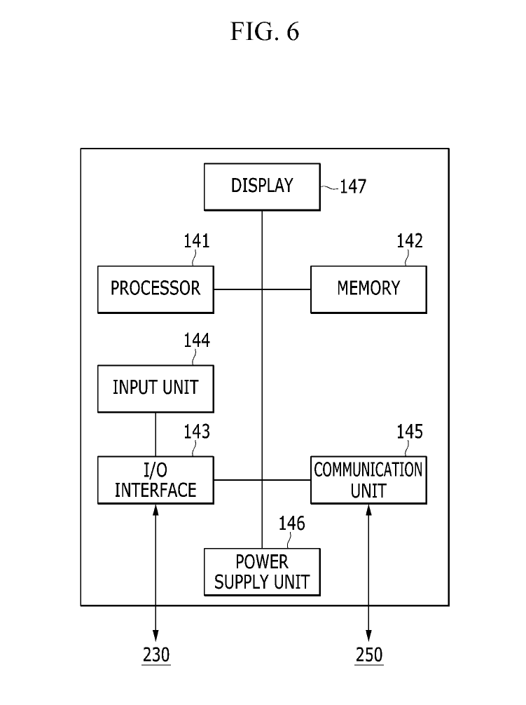

FIG. 6 is a view showing the power and status display of FIG. 1.

Referring to FIG. 6, the power and status display 140 includes a processor 141, a memory 142, an I/O interface 143, an input unit 144, a communication unit 145, a power supply unit 146, and a display 147.

The processor 141 may be implemented as a CPU, a chipset, a microprocessor, etc.

The memory 142 may be implemented as media such as a DRAM, an RDRAM, an SDRAM, and an SRAM.

The I/O interface 143 allows the processor 141 and/or the memory 142 to access the computer system 200 in a wired manner. That is, the power consumption information and status information of the computer system 200 may be received from the computer system 200 via the I/O interface 143, or the power saving policy from the input unit 144 may be transmitted to the computer system 200.

The input unit 144 is connected to the I/O interface 144, and supports the establishment of a simple power saving policy without using an input device on the computer system 200. In addition, the input unit 144 may receive control instructions for the computer system 200 from the user. The control instructions may include, for example, information on the power saving mode and power on/off mode the user wants to control. A button or the like may be provided as the input unit 144.

The communication unit 145 allows the processor 141 and/or the memory 142 to access the computer system 200 in a wired manner. That is, the power consumption information and status information of the computer system 200 may be received from the computer system 200 via the communication unit 145, or the power saving policy from the input unit 144 or the on/off instructions for the computer system 200 may be transmitted to the computer system 200.

The power supply unit 146 supplies power to the power and status display 140. The power supply unit 146 may include a battery.

The power supply unit 147 displays the power consumption information and status information of the computer system 200 received via the I/O interface 143. The display 147 is an LCD (liquid crystal display), an LED (light emitting diode) display, a PDP (plasma display panel), etc., which may be flexible.

As the power and status display 140 has its own power supply unit 146 as stated above, it can operate independently from the computer system 200. Accordingly, the power and status display 140 can display the power consumption information and status information of the computer system 200 even when the computer system 200 is completely powered off.

The power and status display 140 of this type may be attached as a patch to a wide variety of items.

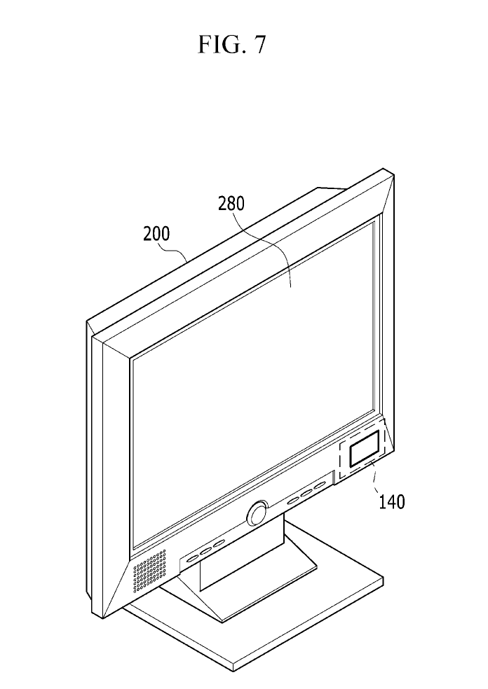

FIGS. 7 to 12 are views showing examples of mounting of the power and status display of FIG. 6.

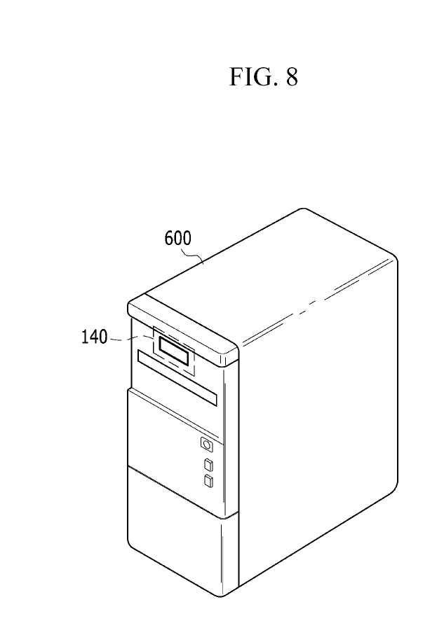

As shown in FIGS. 7 and 8, the power and status display 140 may be mounted on a bezel, i.e., an external frame, of the display device 280 of the computer system 200, that is, on a part of a main body 600 of the computer system 200.

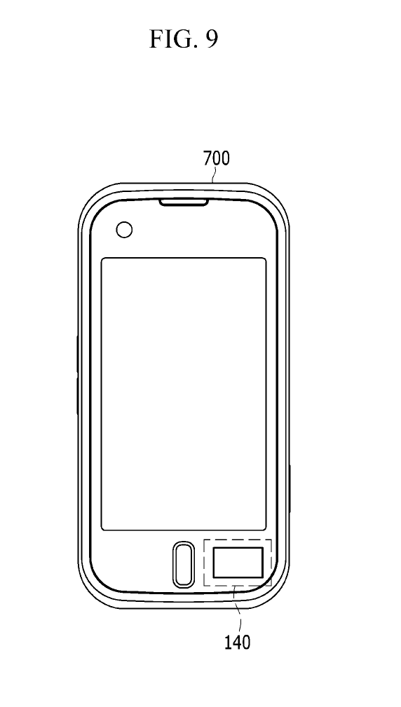

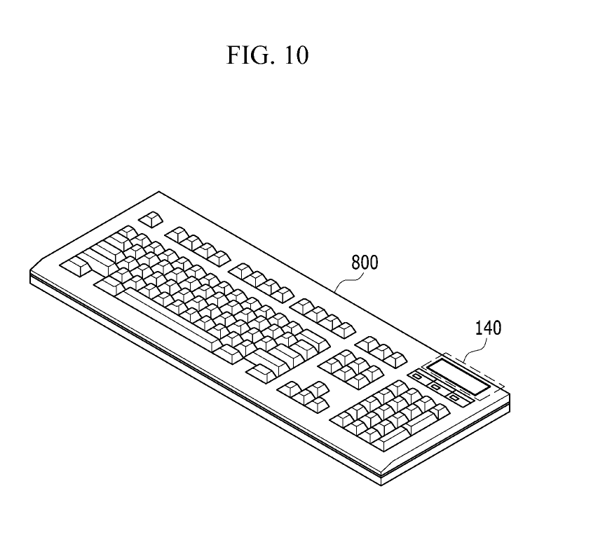

Alternatively, the power and status display 140 may be mounted on a part of a mobile terminal 700 the user carries, as shown in FIG. 9, or mounted on a keyboard 800, as shown in FIG. 10.

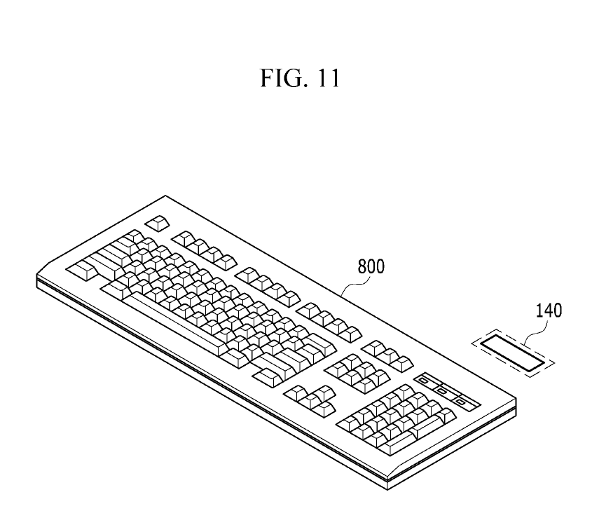

The power and status display 140 may be wirelessly connected to the computer system 200, as shown in FIG. 11, and placed in a position within a predetermined distance for the computer system 200, for example, next to the keyboard 800.

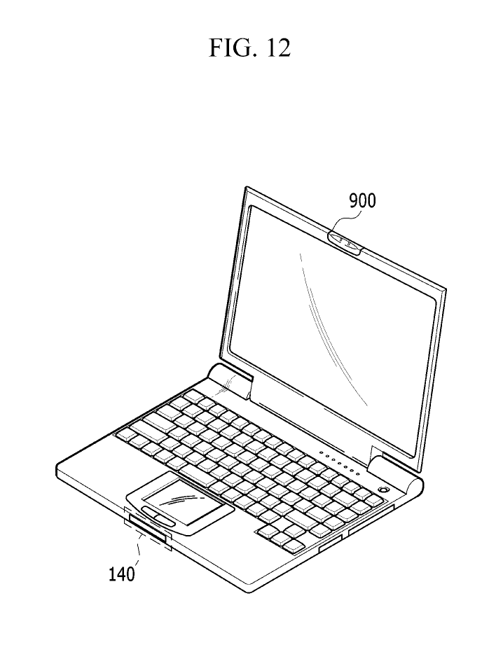

In case of a laptop computer 900, as shown in FIG. 12, the power and status display 140 may be mounted on the outer edge of the case of the laptop computer 900 so that it can be seen even when the cover of the laptop computer 900 is closed. In the laptop computer, the power and status display 140 may additionally display remaining battery level information, etc.

The mounting position of the power and status display 140 is not limited thereto, but may be mounted anywhere so long as the user can see it with ease.

That is, the power and status display 140 may be mounted anywhere near the display device 280 of the computer system 200 so that the user can get the power consumption information and status information of the computer system 200 through the power and status display 140 even when the display device 280 of the computer system 200 is in an off condition.

According to an embodiment of the present invention, the computer system's power consumption and status information can be provided when the computer system is switched to a power saving mode or the like and the display device is not on. Accordingly, the user can recognize the computer system's power consumption and status information with ease. In addition, the computer system is enabled to operate in a power saving mode or return to a normal mode, without using an input device on the computer system. Accordingly, power consumption can be reduced.

The embodiment of the present invention described above is not implemented by only the method and apparatus, but it may also be implemented by a program for executing the functions corresponding to the configuration of the exemplary embodiment of the present invention or a recording medium having the program recorded thereon. These implementations can be realized by the ordinarily skilled person in the art from the description of the above-described exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for power saving in a computer system, the apparatus comprising:
a policy register that registers a power saving policy for the computer system;
a power saving controller that collects the computer system's status information and power consumption information, and controls the power to at least one auxiliary device of the computer system based on the computer system's status information and the power saving policy; and
a power and status display that is mounted at a remote location, and displays the computer system's power consumption information and status information.

2. The apparatus of claim 1, further comprising a remote status transmitter that transmits the computer system's power consumption information and status information to the power and status display by wired or wireless communication.

3. The apparatus of claim 2, wherein
the computer system comprises a processor, a memory, an input/output (I/O) interface, and a communication unit, and
the processor loads program instructions to the memory to implement at least some of the functions of the policy register, power saving controller, and remote status transmitter, and
the computer system's power consumption information and status information are transmitted to the power and status display via the I/O interface or the communication unit.

4. The apparatus of claim 1, wherein
the power and status display comprises:
a display that displays the computer system's power consumption information and status information; and
a power supply unit that supplies power to the power and status display.

5. The apparatus of claim 4, wherein
the power and status display further comprises:
an I/O interface or communication unit that receives the computer system's power consumption information and status information; and
an input unit that receives user input of information on the power saving policy, power saving mode, and power on/off mode.

6. The apparatus of claim 1, wherein the power and status display has a patch form.

7. The apparatus of claim 1, wherein the remote location comprises at least one of a main body of the computer system, a bezel of a monitor, a user's mobile terminal, a keyboard, and a position within a predetermined distance of the computer system.

8. The apparatus of claim 1, wherein
the power saving controller turns off power to the display device of the computer system based on the status information when the computer system operates in a power saving mode, and
the power saving mode comprises at least either a standby mode or a screensaver mode.

9. A method for power saving in a computer system by a power saving apparatus, the method comprising:
receiving the computer system's power consumption information;
collecting the computer system's status information;
controlling power to at least one auxiliary device of the computer system according to the computer system's status information and an established power saving policy; and
transmitting the computer system's power consumption information and status information to a display device at a remote location so that the display device at the remote location displays the computer system's power consumption information and status information.

10. The method of claim 9, wherein
the controlling comprises:
detecting activation of a power saving mode according to the status information and the power saving policy; and
turning off power to the display device of the computer system when the power saving mode is active.

11. The method of claim 10, wherein the power saving mode comprises at least either a standby mode or a screensaver mode.

12. The method of claim 9, wherein the controlling comprises receiving input of the power saving policy from the user or through the computer system.

13. The method of claim 9, wherein
the computer system comprises a processor, a memory, an input/output interface, and a communication unit,
the processor loads program instructions to the memory to implement at least some of the receiving, controlling, collecting, and transmitting, and
the transmitting is performed via the input/output interface or the communication unit.

14. The method of claim 9, further comprising registering a power saving policy for the computer system.

15. The method of claim 9, wherein
the remote location comprises at least one a main body of computer system, a bezel of a monitor, a user's mobile terminal, a keyboard, and a position within a predetermined distance of the computer system, and
the display device is mounted as a patch at the remote location.

16. The method of claim 9, wherein the status information comprises at least either the computer system's advanced configuration and power interface (ACPI) state, or mode setting information for the power saving policy.

17. The method of claim 9, wherein the status information further comprises at least one of information on temperature and humidity in the computer system, voltage and current of a power supply device, and internal fan speed.

18. The method of claim 17, wherein, if the computer system uses a battery, the status information further comprises remaining battery level information.

19. The method of claim 9, further comprising:
receiving control instructions for the computer system from the user; and
transmitting the control instructions to the computer system.

20. The method of claim 19, wherein the control instructions comprise information on the power saving policy, power saving mode, and power on/off mode for the computer system.
